(19) United States
(12) Patent Application Publication
(10) Pub. No.: US 2004/0227826 A1
(43) Pub. Date: Nov. 18, 2004

(54) Device and method to determine exposure setting for image of scene with human-face area

(75) Inventors: Mu-Hsing Wu, Taoyuan (TW); Chao-Lien Tsai, Taoyuan (TW); Hung-Chi Tsai, Taoyuan (TW)

Correspondence Address: Richard P. Berg. Esq., c/o LADAS & PARRY, Suite 2100, 5670 Wilshire Boulevard, Los Angeles, CA, 90036-5679, US

(73) Assignee: BENQ CORPORATION

(21) Appl. No.: 10/846,071

(22) Filed: May 14, 2004

(30) Foreign Application Priority Data
May 16, 2003 (TW) 092113280

(51) Int. Cl. H04N 5/262

(52) U.S. Cl. 348/239

(57) ABSTRACT

The invention provides a device and method to determine the exposure setting for an image of a scene with human-face area. Human-face-contour-like patterns are provided in advance. The human-face area of the scene is approximately determined according to a rule, and the specific unit of an exposure metering matrix for the image is also determined. The specific unit relates with the human-face area in the scene. Changing the weighting of the specific unit helps to modify the exposure metering matrix. The exposure setting of the image being captured is then determined according to the modified exposure metering matrix.

### BACKGROUND OF THE INVENTION

1. Field of the Invention

The present invention relates to a device and method for determining the exposure settings of an image, and more particularly, the present invention relates to a device and method for determining the exposure settings of the image relating to a scene which presents a human-face area.

2. Description of the Prior Art

Correct exposure settings are necessary for capturing a clear image by a digital image capturing device. The exposure settings of a digital image capturing device are determined by the result of the metering mode. The matrix metering is one of the most common metering modes. The matrix metering divides the image captured by the digital image capturing device into a plurality of units and form a metering matrix. Then, the digital image capturing device analyzes the light intensity of multiple different units of the metering matrix. The digital image capturing device distributes the metering weighting according to the analyzed result and obtains a metering weighting matrix.

Therefore, the digital image capturing device can obtain an image with correct exposure settings for a captured scene because of the metering modes. However, if a scene comprises human faces, and the contrast between the bright and dark areas of the scene is too large, or the metering weighting of the human-face area is too low, the human-face area of the image, which is often the main body of an image, will still have incorrect exposure settings. As a result, the digital image capturing device is unable to obtain a subjectively satisfying image. Therefore, it is necessary to suitably modify the exposure weighting of the human-face area of the scene to obtain the correct exposure settings of the human-face area.

### SUMMARY OF THE INVENTION

Accordingly, an objective of the invention is to provide an exposure setting device and method thereof, applied in the digital image capturing device, to dynamically modify the exposure setting of the digital image capturing device to capture an image relating to a scene presenting a human-face area.

Another objective of the invention is to obtain the correct exposure setting of the human-face area to improve the disadvantage of the prior art.

The present invention provides an exposure setting device applied in an image forming apparatus. The exposure setting device is used for determining the exposure setting of a captured first image. The first-image relates to a scene that presents a human-face area. The exposure setting device comprises a storing module, an image capturing module, an exposure controlling module, a first processing module, a first analyzing module, a second processing module, and a second analyzing module. The storing module pre-stores a plurality of human-face-contour-like patterns. The image capturing module captures the scene presenting the human-face area and then generates a second image. The exposure controlling module generates a corresponding exposure metering matrix based on the captured second image. The first processing module generates at least one down-sampled second image according to the captured second image; it also fetches out the first information separately from the captured second image and the down-sampled second images. Based on the plurality of human-face-contour-like patterns, the first analyzing module separately analyzes the first information from the captured second image and the down-sampled second images and further determines a first area, which points to the human-face area of the scene, in the second image. The second processing module fetches out at least one second information from the first area. The second analyzing module analyzes the second information according to at least one rule and further determines a second area from the first area of the captured second image. The second area broadly points to the human-face area of the scene. The second analyzing module determines a specific unit, which points to the human-face area of the scene, in the exposure metering matrix, according to the second area of the captured second image.

The exposure controlling module increases the weighting of the specific unit, then further modifies the exposure metering matrix. The exposure controlling module then determines the exposure setting of the captured first image, according to the modified exposure metering matrix, and controls the image capturing module to capture the first image according to the exposure setting.

Therefore, the exposure setting device and method of the present invention can dynamically modify the exposure setting of the digital image capturing device to capture an image relating to a scene presenting the human-face area, thus obtaining the correct exposure setting of the human-face area of the scene.

The advantage and spirit of the invention may be understood by the following recitations together with the appended drawings.

### BRIEF DESCRIPTION OF THE APPENDED DRAWINGS

FIG. 1 is a function block diagram of an exposure setting device of an image forming apparatus according to the present invention.

FIG. 2 is a schematic diagram of the plurality of human-face-contour-like patterns pre-stored in the storing module shown in FIG. 1.

FIG. 3 is a schematic diagram of the two down-sampled second images generated by the first processing module shown in FIG. 1.

FIG. 4 is a schematic diagram of the second area of the second image shown in FIG. 3.

FIG. 5 is a flow chart of the method for determining the exposure setting of the human-face area of the scene.

### DETAILED DESCRIPTION OF THE INVENTION

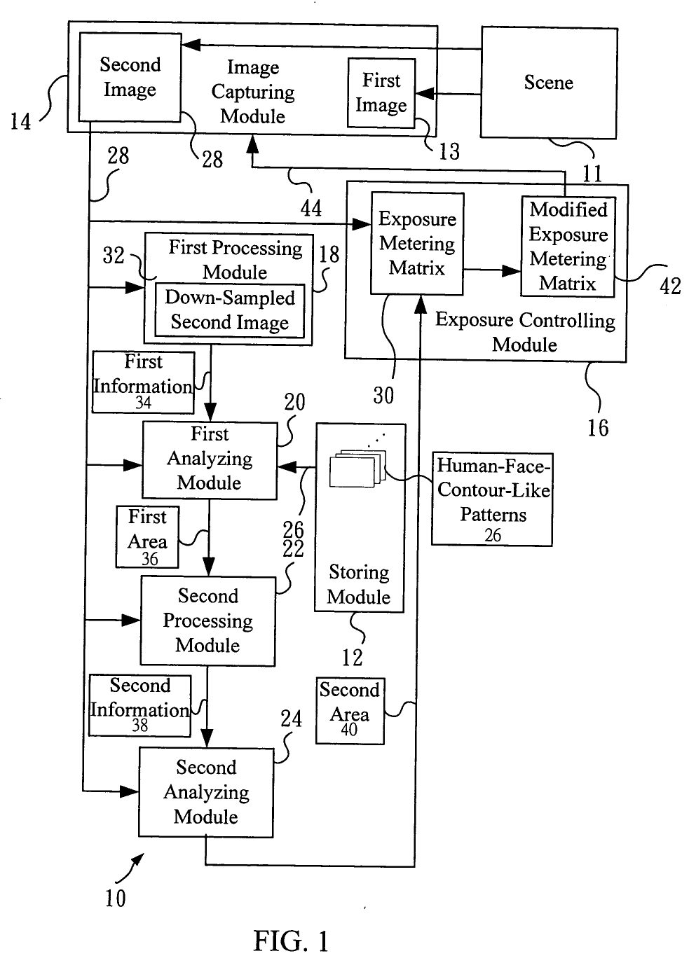

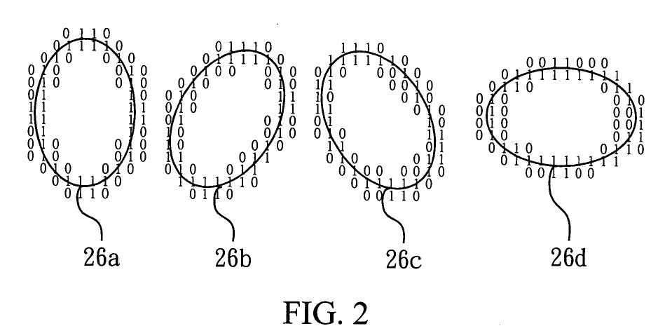

Referring to FIG. 1 and FIG. 2, FIG. 1 is a function block diagram of an exposure setting device 10 of an image forming apparatus according to the present invention. FIG. 2 is a schematic diagram of a plurality of human-face-contour-like patterns 26 pre-stored in the storing module 12 shown in FIG. 1. The exposure setting device 10 of the present invention is used for determining the exposure setting of a captured first image 13. The first-image 13 relates to a scene 11 which presents a human-face area. The exposure setting device 10 comprises a storing module 12, an image capturing module 14, an exposure controlling module 16, a first processing module 18, a first analyzing module 20, a second processing module 22, and a second analyzing module 24.

The storing module 12 pre-stores a plurality of human-face-contour-like patterns 26, wherein the format for storing the human-face-contour-like patterns 26 is a binary matrix, with ‘1’ representing the human-face contour (i.e. the black line shown in FIG. 2), and ‘0’ representing the non-human-face contour. The human-face-contour-like patterns are inputted into the first analyzing module 20. As the embodiment shown in FIG. 2, the storing module pre-stores four human-face-contour-like patterns 26a, 26b, 26c, and 26d. The image capturing module 14 is used for capturing the human-face area of the scene 11, further generating a second image 28. The exposure controlling module 16 is used for generating an exposure metering matrix 30 based on the captured second image 28.

The first processing module 18 is used for generating at least one down-sampled second image 32, according to the captured second image 28, and fetching a first information 34 from the captured second image 28 and the at least one down-sampled second image 32 respectively.

The first analyzing module 20 is used for separately analyzing the first information 34 of the captured second image 28 and the at least one down-sampled second image 32, based on the plurality of human-face-contour-like patterns 26a, 26b, 26c, and 26d, and further determining a first area 36, which probably points to the human-face area of the scene 11, in the second image 28.

The second processing module 22 is used for fetching at least one second information 38 from the first area 36.

The second analyzing module 24 is used for analyzing the at least one second information 38 according to at least one rule, then determining a second area 40 from the first area 36 of the captured second image 28. The second area 40 broadly points to the human-face area of the scene 11. The second analyzing module 24 also determines a specific unit, which points to the human-face area of the scene 11, of the exposure metering matrix 30 according to the second area 40 of the captured second image 28.

The exposure controlling module 16 increases the weighting of the specific unit, and further modifies the exposure metering matrix 30. The exposure controlling module 16 then determines the exposure setting of the captured first image 13 according to the modified exposure metering matrix 42. Moreoever, the exposure controlling module 16 outputs a controlling signal 44 for controlling the image capturing module 14 to capture the first image 13 according to the exposure setting.

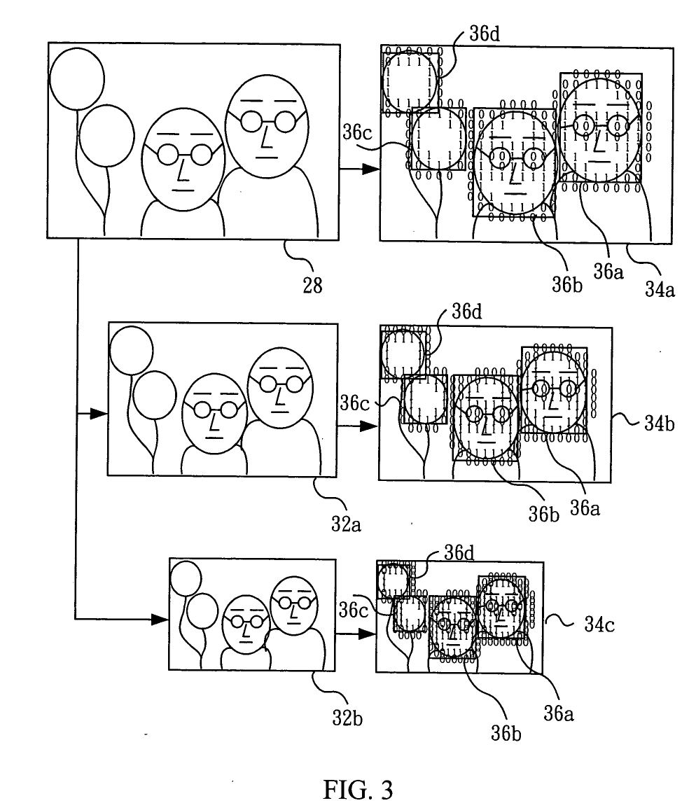

Referring to FIG. 3, FIG. 3 is a schematic diagram of the two down-sampled second images 32a, 32b generated by the first processing module 18 shown in FIG. 1. In the embodiment of FIG. 3, the second image 28 generates the two down-sampled second images 32a and 32b after being calculated by the first processing module 18 .

Referring to FIG. 3, the first processing module 18 selects the Y data (brightness) from the second image 28 and the two down-sampled second image 32a and 32b. Also, after the high-pass filter captures the image-contour data from the Y data and performs the binary arithmetic operation, the first information 34a, 34b, and 34c, which is the distribution of ‘0’ and ‘1’ shown in FIG. 3, is generated. The place representing ‘1’ shows the contour of an object in the image, and the place representing ‘0’ shows the non-contour area of the object in the image.

As shown in FIG. 2 and FIG. 3, the first analyzing module 20 analyzes the first information 34a, 34b, and 34c of the captured second image 28 and the two down-sampled second images 32a and 32b separately, based on the plurality of human-face-contour-like patterns 26a, 26b, 26c, and 26d. Because the brightness contrast of the edge area between the body and background is large, the edge area between the body and background in the first information 34a, 34b, and 34c forms a common border area, like the ‘0’ and ‘1’ in FIG. 3. The first analyzing module 20 compares the shape of the common border area with the plurality of human-face-contour-like patterns 26a, 26b, 26c inputted from the storing module 12 and determines the first areas 36a, 36b, 36c, and 36d, which points to the human-face area of the scene 11, in the captured second image 28.

Besides, the second processing module 22 fetches the Cb data and the Cr data from the first areas 36a, 36b, 36c, and 36d of the captured second image 28 and generates the second information 38.

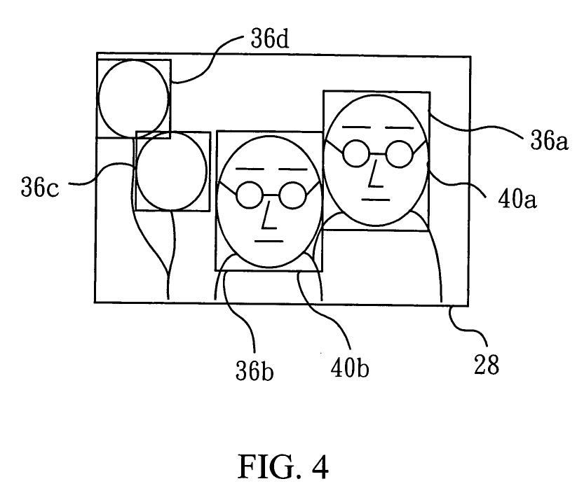

Referring to FIG. 4, FIG. 4 is a schematic diagram of the second area 40 of the second image 28 shown in FIG. 3. After the second information 38 is generated, the second analyzing module 24 analyzes the second information 38 according to the rule, further determining the second areas 40a and 40b from the first areas 36a, 36b, 36c, and 36d of the captured second image 28. The rule is used for determining whether the color of the first areas 36a, 36b, 36c, and 36d of the second image 28 is similar to the human-face color. The rule definitions are described as follows:

−33≦Cb≦−13

19≦Cr≦39

In the embodiment of FIG. 3 and FIG. 4, the human-face area of the scene 11 comprises two human-face areas and two balloon areas. The second analyzing module 24 determines the second areas 40a and 40b from the first areas 36a, 36b, 36c, and 36d of the captured second image 28 according to the above rule. The second areas 40a and 40b points approximately to the human-face area of the scene 11. In FIG. 4, because the first areas 36c and 36d of the two balloons on the left, which also points to scene 11 approximately, do not satisfy the rule, the first areas 36c and 36d are not determined as the second area 40. The second analyzing module 24 also determines the specific unit, which points to the human-face area of the scene 1, of the exposure metering matrix 30 according to the second areas 40a and 40b of the second image 28.

Therefore, the exposure controlling module 16 increases the weighting of the specific unit determined by the second analyzing module 24, further modifying the exposure metering matrix. The exposure controlling module 16 then determines the exposure setting of the captured first image 13, according to the modified exposure metering matrix 42, and outputs the controlling signal 44 for controlling the image capturing module 14 to capture the first image 13 according to the exposure setting outputted from the exposure controlling module 16.

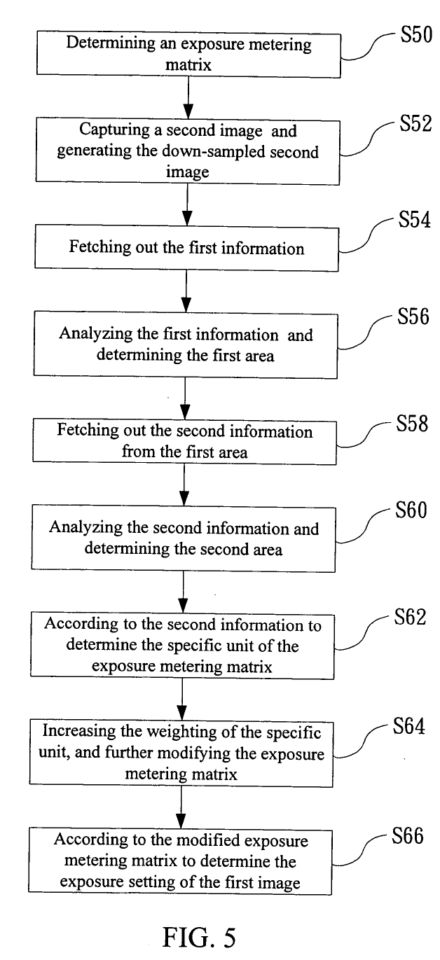

Referring to FIG. 5, FIG. 5 is a flow chart of the method for determining the exposure setting of the human-face area of the scene 1. The setting method of the exposure setting device 10 of the present invention shown in FIG. 1 is detailedly described in the next paragraphs. The exposure setting method of the present invention comprises the following steps:

Step S50: Determine an exposure metering matrix 30 of the first image 13 according to a predetermined logic.

Step S52: Capture a second image 28 related to the scene 11, and generate at least one down-sampled second image 32 based on the captured second image 28.

Step S54: Fetch the Y data (brightness) from the captured second image 28 and the at least one down-sampled second image 32 separately, and after processed by the high-pass filter which captures the image-contour data and performs the binary arithmetic operation, generate a first information 34.

Step S56: Basing on the plurality of human-face-contour-like patterns 26, analyze the first information 34 of the captured second image 28 and the least one down-sampled second image 32 separately, and then determine the first area 36, which points to the human-face area of the scene 11, in the second image 28.

Step S58: Fetch the Cb data and Cr data from the first area 36 of the captured second image 28, and then generate at least one second information 38.

Step S60:Analyze the at least one second information 38 of the captured second image 28 according to the rules shown as the following functions, and then determine the second area 40 from the first area 36 of the captured second image 28, wherein the second area 40 points to the human-face area of the scene 11. The functions of the rules comprise:

−33≦Cb≦−13

19≦Cr≦39

Step S62: According to the second area 40 of the captured second image 28, determine the specific unit, which points to the human-face area of the scene 11, of the exposure metering matrix 30.

Step S64: Increase the weighting of the specific unit, and further modify the exposure metering matrix 30.

Step S66: According to the modified exposure metering matrix 42, determine the exposure setting of the captured first image 13.

Therefore, the exposure setting device 10 and method of the present invention can dynamically modify the exposure setting of the digital image capturing device to the human-face area of the scene 11, and obtain the correct exposure setting of the human-face area of the scene 11.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An exposure setting device applying in an image forming apparatus for determining the exposure setting of a first image being captured, the first-image relating to a scene which presents a human-face area, the exposure setting device comprising:
a storing module for pre-storing a plurality of human-face-contour-like patterns;
an image capturing module for capturing the scene and then generating a second image;
an exposure controlling module for generating an exposure metering matrix based on the captured second image;
a first processing module for generating at least one down-sampled second image according to the captured second image and fetching a first information from the captured second image and the at least one down-sampled second image separately;
a first analyzing module for analyzing the first information of the captured second image and the at least one down-sampled second image separately based on the plurality of human-face-contour-like patterns, and then determining a first area, which possibly points to the human-face area of the scene, in the second image;
a second processing module for fetching at least one second information from the first area; and
a second analyzing module for analyzing the at least one second information according to at least one rule, then determining a second area from the first area of the captured second image, wherein the second area points to the human-face area of the scene, and determining a specific unit, which points to the human-face area of the scene of the exposure metering matrix according to the second area of the captured second image;
wherein the exposure controlling module increases the weighting of the specific unit and further modifies the exposure metering matrix; the exposure controlling module then determining the exposure setting of the captured first image according to the modified exposure metering matrix, and controlling the image capturing module to capture the first image according to the exposure setting.

2. The device of claim 1, wherein the first information is the Y data (brightness) selected from the captured second image and the at least one down-sampled second image, and processed by the high-pass filter which captures the image-contour data and performs the binary arithmetic operation.

3. The device of claim 2, wherein the at least one second information comprises a Cb data fetched from the captured second image.

4. The device of claim 3, wherein the at least one rule comprises one rule definition as follow:
−33≦Cb≦−13

5. The device of claim 2, wherein the at least one second information comprises a Cr data fetched from the captured second image.

6. The device of claim 5, wherein the at least one rule comprises the one rule definition as follows:
19≦Cr≦39°

7. An exposure setting method for determining the exposure setting of a first image being captured, the first-image being captured relating to a scene which presents a human-face area, the exposure setting method comprising:
providing a plurality of human-face-contour-like patterns;
determining an exposure metering matrix of the first image according to a predetermined logic;
capturing a second image related to the scene, and generating at least one down-sampled second image based on the captured second image;
fetching out a first information from the captured second image and the at least one down-sampled second image separately;
analyzing the first information of the captured second image and the at least one down-sampled second image separately based on the plurality of human-face-contour-like patterns, and then determining the first area, which points to the human-face area of the scene, in the second image;
fetching out at least one second information from the first area of the captured second image;
analyzing the at least one second information of the captured second image according to at least one rule, and then determining the second area from the first area of the captured second image, wherein the second area points to the human-face area of the scene;
according to the second area of the captured second image, determining the specific unit, which points to the human-face area of the scene, of the exposure metering matrix;
increasing the weighting of the specific unit, and further modifying the exposure metering matrix; and
determining the exposure setting of the first image being captured according to the modified exposure metering matrix.

8. The method of claim 7, wherein the first information is the Y data (brightness) selected from the captured second image and the at least one down-sampled second image, and processes by the high-pass filter which captures the image-contour data and performed the binary arithmetic operation.

9. The method of claim 8, wherein the at least one second information comprises a Cb data fetched out from the captured second image.

10. The method of claim 9, wherein the at least one rule comprises one rule definition as follow:
−33≦Cb≦−13

11. The method of claim 8, wherein the at least one second information comprises a Cr data fetched out from the captured second image.

12. The method of claim 11, wherein the at least one rule comprises one rule definition as follow:
19≦Cr≦39°
